(19) United States
(12) Patent Application Publication
(10) Pub. No.: US 2013/0139043 A1
(43) Pub. Date: May 30, 2013

(54) SYSTEM, APPARATUS AND METHOD FOR UPDATING LINKS

(71) Applicant: OneScreen Inc., Irvine, CA (US)

(72) Inventors: Atul Patel, Irvine, CA (US); Patrick Ting, Duarte, CA (US)

(73) Assignee: OneScreen Inc., Irvine, CA (US)

(21) Appl. No.: 13/680,028

(22) Filed: Nov. 17, 2012

Related U.S. Application Data
(60) Provisional application No. 61/564,675, filed on Nov. 29, 2011.

(51) Int. Cl. G06F 17/00

(52) U.S. Cl. 715/205

(57) ABSTRACT

A system, apparatus and method are provided for automatically updating links on a webpage. In one or more embodiments, a landing page can receive new content from a content provider and can replace the old content with the new content on the landing page. When the landing page has been updated, the webpage containing links to the landing page are also automatically updated to correctly describe the new content that is being displayed on the landing page.

### CROSS-REFERENCE TO RELATED APPLICATION

This application claims the benefit of U.S. Provisional Patent Application No. 61/564,675, filed on Nov. 29, 2011. The subject matter thereof is hereby incorporated herein by reference in its entirety.

### FIELD

The present invention relates to an apparatus and method for updating links and, more particularly, to an apparatus and method for updating links on a webpage when content on a landing page has changed.

### BACKGROUND

Currently, banner ads and other modular content items, such as web widgets on the Internet, are driven by cookies, geographic location, etc. For example, there are tools that review, amongst other things, the user's cookies and geographical location in order to generate ads on a given webpage visited by a user. Such ads, text, videos, or other content items (each, a “link”) will then connect a webpage user to a specific predetermined landing or destination page. The company owning the specific landing page must buy placement on different webpages for links, the update of which may be expensive and time consuming. Also, every time the company wishes to change a link, the company must buy an additional spot for placement of that link.

### SUMMARY

Certain embodiments of the present invention may provide solutions to the problems and needs in the art that have not yet been fully identified, appreciated, or solved by current systems for directing traffic to one or more landing pages.

One or more embodiments pertain to an apparatus and method for automatically updating links on a webpage by displaying a link that is associated with the content displayed on the landing page. For example, when content is updated on the landing page, the webpage containing the link to the landing page is automatically updated.

In one embodiment, an apparatus includes a processor and memory comprising instructions. The instructions, when executed by the processor, are configured to cause the apparatus to receive a content update message when content on a landing page is updated. The instructions, when executed by the processor, are further configured to cause the apparatus to transmit an update message to a server of a webpage to automatically update a link on the webpage to reflect the updated content on the landing page.

In another embodiment, a computer-implemented method includes receiving, by a computing system, a content update message when content on a landing page is updated. The computer-implemented method also includes transmitting, by the computing system, an update message to a server of a webpage to automatically update a link on the webpage to reflect the updated content on the landing page.

In yet another embodiment, an apparatus includes a processor and memory comprising instructions. The instructions, when executed by the processor, are configured to cause the apparatus to transmit a request message to a server of a landing page for updates to content of the landing page. The instructions, when executed by the processor, are further configured to cause the apparatus to receive a response message from the server of the landing page when the content of the landing page is updated, and transmit an update message to a server of a webpage to automatically update a link on the webpage.

In yet a further embodiment, a system for automatically updating links is provided. The system includes a central server and a server of a webpage. The central server is configure to receive a request message from the server of the webpage for updates to content on a landing page, and transmit an update message comprising at least one updated link to the server of the webpage when the content on the landing page is updated. The server of the webpage is configured to automatically update one or more existing links on the webpage with the at least one updated link when the content of the landing page is updated.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a block diagram of a system that can be implemented in one or more embodiments of the present invention.

FIG. 2 illustrates a system for automatically updating links on a webpage, in accordance with an embodiment of the present invention.

FIG. 3 illustrates a system for automatically updating links on a webpage, in accordance with an embodiment of the present invention.

FIG. 4 illustrates a system for automatically updating links on a webpage, in accordance with an embodiment of the present invention.

FIG. 5 illustrates a system for automatically updating links on a webpage, in accordance with an embodiment of the present invention.

FIG. 6 illustrates a system for automatically updating links on a webpage, in accordance with an embodiment of the present invention.

FIG. 7 illustrates a method for transmitting new content, in accordance with an embodiment of the present invention.

FIG. 8 illustrates a method for automatically updating a landing page with new content, in accordance with an embodiment of the present invention.

FIG. 9 illustrates a method to automatically update links on a webpage, in accordance with an embodiment of the present invention.

### DETAILED DESCRIPTION OF THE EMBODIMENTS

It will be readily understood that the components of the invention, as generally described and illustrated in the figures herein, may be arranged and designed in a wide variety of different configurations. Thus, the following detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One or more embodiments described herein pertain to an apparatus and method for automatically updating links by displaying a link that is associated with the content displayed on the landing page. For instance, if Colgate® content is being displayed on the landing page, associated banner ads or other links that direct a webpage user to the landing page will be related to Colgate®. When, for example, the landing page changes its content from promoting Colgate® to Nike®, any banner ads or link will change thereafter and be related to Nike®. In other words, the appearance of a link, or links, placed on a webpage will change based on the landing or destination page.

In some embodiments, links can also be updated utilizing a central (or state) server that receives a request from a webpage module having the link and the server then requests a landing page module for information being displayed on the landing page. The server then receives the response from the landing page module and instructs the webpage module to replace old links with new links on the webpage.

This allows companies to purchase placement for a single link on a webpage instead of multiple placements, as well as allows the companies to update any corresponding link based on the contents displayed on the landing or destination page.

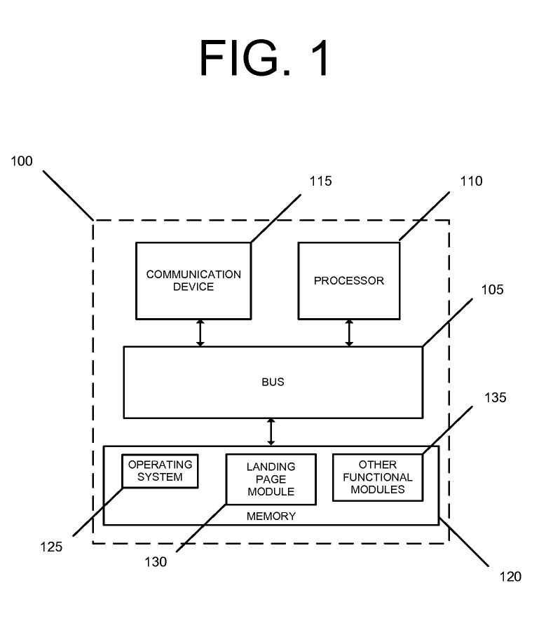

FIG. 1 illustrates a block diagram of a system 100 that can be implemented in one or more embodiments of the present invention. System 100 may include a bus 105 or other communication mechanism that can communicate information and a processor 110, coupled to bus 105, that can process information. Processor 110 can be any type of general or specific purpose processor. System 100 may also include memory 120 that can store information and instructions to be executed by processor 110. Memory 120 can be comprised of any combination of random access memory (“RAM”), read only memory (“ROM”), static storage such as a magnetic or optical disk, or any other type of computer readable medium. System 100 may also include a communication device 115, such as a network interface card, that may provide access to a network.

The computer readable medium may be any available media that can be accessed by processor 110. The computer readable medium may include both volatile and nonvolatile medium, removable and non-removable media, and communication media. The communication media may include computer readable instructions, data structures, program modules, or other data and may include any information delivery media.

According to one embodiment, memory 120 may store software modules that may provide functionality when executed by processor 110. The modules can include an operating system 125 and a landing page module 130 or a webpage module, as well as other functional modules 135. In one or more embodiments, landing page module 130 can replace old content with new content that is received by one or more content providers. In one or more embodiments, and the webpage module can replace old links with news links on a webpage to accurately describe the new content that is now being shown on the landing page. It should be appreciated that landing page module 130 and the webpage module can be on different servers or on the same server depending on the design of the system. Operating system 125 may provide operating system functionality for system 100. Because system 100 may be part of a larger system, system 100 may include one or more additional functional modules 135 to include the additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

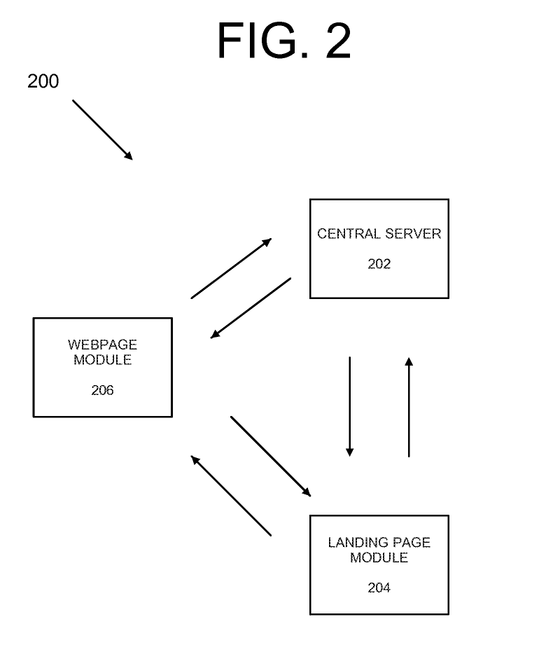

FIG. 2 illustrates a system 200 for automatically updating links on a webpage, in accordance with an embodiment of the present invention. System 200 may include, amongst other components, a central server 202, a landing page module 204, and a webpage module 206. It should be appreciated that system 200 may include more than one server. Landing page module 204 and webpage module 206 may embodied on a single server, separate servers (not shown), or central server 202, depending on the configuration of system 200. Landing page module 204 is configured to change an advertisement or any content that a content provider (not shown) may want to promote on a landing page.

In this embodiment, when landing page module 204 receives new content that the content provider wants to promote, landing page module 204 updates the landing page and transmits a message to central server 202 that new content has been added to the landing page. The message can also contain an updated link to the landing page. The link can direct a user accessing a webpage to the new content on the landing page. The link may be text, a banner advertisement, a picture, etc., and the new content may be related to the text, a picture, audio, video, etc.

To update or replace the old links on the webpage, central server 202 can transmit a message to webpage module 206 to indicate that new content has been added, or has replaced the old content, on the landing page. The message can include the new link associated with the new content on the landing page. Webpage module 206 can replace the old link or links with the new link or links on the webpage in order to direct a user to the landing page.

In an alternative embodiment, webpage module 206 may periodically request central server 202, or landing page module 204, for any updates regarding the content on the landing page. It should be appreciated that in one or more embodiments the webpage module 206 can be a meta tag (or JavaScript) placed on the header of each webpage in order to periodically transmit requests to central server 202 or landing page module 204. If there has been an update to the content on the landing page, central server 202 or landing page module 204 can transmit a message containing the new link to webpage module 206. Webpage module 206 can then replace the old link with the new link associated with the new content on the landing page.

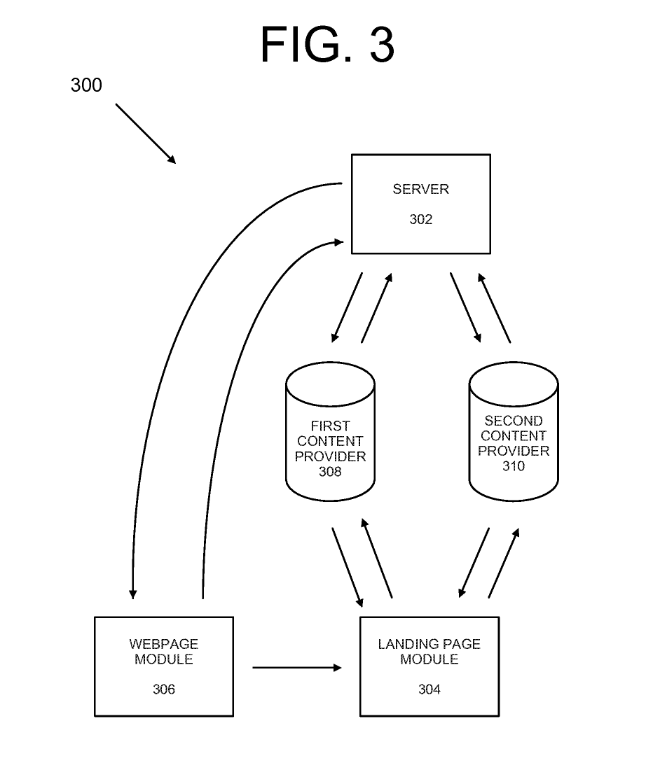

FIG. 3 illustrates a system 300 for automatically updating links on a webpage, in accordance with an embodiment of the present invention. System 300 includes a server (central or state server) 302, a landing page module 304, a webpage module 306, and at least a first content provider 308 and a second content provider 310. It should be appreciated that system 300 may include a plurality of landing page modules and webpage modules, depending on the configuration of the system.

In this embodiment, a landing page may display content provided by first content provider 308 and/or second content provider 310. For example, when first content provider 308 wants to replace content on the landing page, first content provider 308 transmits a message containing new content to landing page module 304. Landing page module 304 can then replace the old content with new content that first content provider 308 may want to display.

In another embodiment, landing page module 304 may periodically transmit a request to, for example, first and second content provider 308, 310 for new content that the content providers may want to display on the landing page. If first and/or second content provider 308, 310 do not have new content to be displayed on the landing page, then first and/or second content provider 308, 310 can transmit a message indicating that no new content is available, or may not respond. If first and/or second content provider 308, 310 has new content, content providers 308 and/or 310 can transmit a response message containing the new content to landing page module 304.

Landing page module 304, upon receipt of the new content, can then replace the old content on the landing page with the new content on the landing page. For example, if the landing page displays content related to Apple® and the new content relates to Microsoft®, then landing page module 304 replaces the content related to Apple® with the new content related to Microsoft®.

Because content has changed on the landing page, the webpage containing the links to the landing page have to be changed accordingly to correctly refer to the new content. Below is a description to efficiently update the links on the webpage that relate to the new content on the landing page.

In one embodiment, when first and/or second content provider 308, 310 push new content to landing page module 304, first and/or second content provider 308, 310 also pushes or transmits to server 302 a message containing a link to the new content on the landing page. This allows server 302 to transmit a message informing webpage module 306 that the content on the landing page has been changed. The message may also include the link to the new content on the landing page.

Webpage module 306 can then replace the old link with the new link on the webpage in order to correctly display the new link associated with the new content on the landing page. As a result, when a user accesses a webpage, the user can see the updated link instead of an out-of-date link, and the user will be correctly directed to the new content on the landing page when the user selects the link.

In another embodiment, server 302 may periodically transmit a request message to first and second content provider 308, 310 for updates regarding the content on the landing page. In other words, the request message helps server 302 to determine whether the old content has been replaced with new content on the landing page. If server 302 receives a message that old content has been replaced by new content on the landing page, server 302 can then transmit an update message to webpage module 306 in order to update the links on the webpage.

It should be appreciated that the message received from the first and/or second content provider 308, 310, as well as the update message transmitted to webpage module 306, may include a link pertaining to the new content on the landing page. By including the link in the update message, webpage module 306 can efficiently change or replace the link on the webpage to accurately represent the content that is currently being displayed on the landing page. As a result, the user will be directed to the new content on the landing page when the user selects the updated or replaced link.

Alternatively, webpage module 306 can transmit a request message to server 302 for updates regarding the content on the landing page. If the content on the landing page has been updated, server 302 can transmit an update message to webpage module 306. The update message can contain a link to the new content to the landing page so webpage module 306 can replace the old link with the new link on the webpage.

As a result, when the user accesses the webpage, the webpage will display the new link instead of the old link. It should also be appreciated that the system carries out the process of updating the links at run-time or in real-time. For example, the system can update the links when the user accesses the webpage or may be periodically or constantly updating the links.

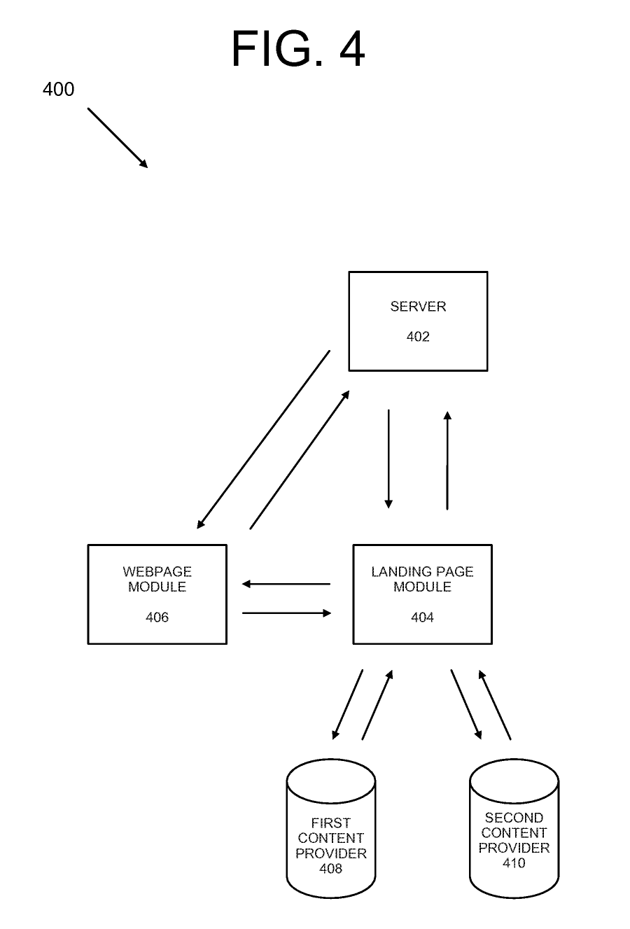

FIG. 4 illustrates a system 400 for automatically updating links on a webpage, in accordance with an embodiment of the present invention. System 400 includes a server 402, a landing page module 404, a webpage module 406, and at least a first content provider 408 and a second content provider 410. It should be appreciated that system 400 may include a plurality of landing page modules and webpage modules, depending on the configuration of the system.

In this embodiment, landing page module 404 can transmit a request message to first and/or second content provider 408, 410 for any updates to the landing page. First and/or second content provider 408, 410 can transmit an update message to indicate whether new content is to be displayed on the landing page. If new content is displayed, then first and/or second content provider 408, 410 transmits a message containing the new content. In another embodiment, first and/or second content provider 408, 410 can periodically notify landing page module 404 that new content is to be displayed on the landing page, and transmit the new content to landing page module 404. As a result, landing page module 404 can update the content on the landing page when new content is received from first and/or second content provider 408, 410.

Because content has changed on the landing page, the webpage containing the links to the landing page has to be changed accordingly to correctly refer to the new content. Below is a description on how the links on the webpage that relate to the new content on the landing page may be efficiently updated.

In one embodiment, when new content replaces the old content on the landing page, landing page module 404 can transmit a message to webpage module 406 and/or server 402 that new content is being displayed on the landing page. The message may also include the link associated with the new content that is being displayed on the landing page. This allows webpage module 406 to receive the new link, and replace the old link with the new link to accurately display the new link on the webpage. As a result, when the user selects the new link, the user will be directed to the landing page displaying the new content, instead of the user selecting an old link on the webpage and then being directed to the old content on the landing page.

In another embodiment, webpage module 406 transmits a request message to landing page module 404 and/or server 402 for updates to the content on the landing page. If new content has replaced the old content, then webpage module 406 receives a reply message from landing page module 404 and/or server 402 to indicate that the old content has been replaced by the new content. The reply message may also include a link that, when selected by the user accessing the webpage, is configured to direct a user to the landing page containing the new content. By receiving the link in the reply message, webpage module 406 can replace the old link with the new link related to the new content being displayed on the landing page.

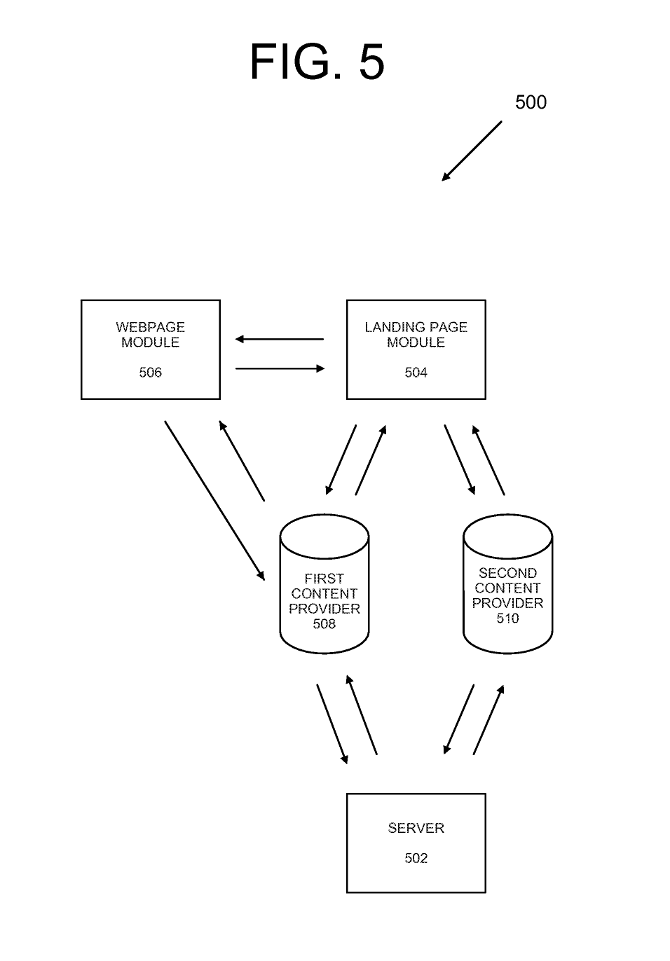

FIG. 5 illustrates a system 500 for automatically updating links on a webpage, in accordance with an embodiment of the present invention. System 500 includes a server 502, a landing page module 504, a webpage module 506, and at least a first content provider 508 and a second content provider 510. It should be appreciated that system 500 may include a plurality of landing page modules and webpage modules, depending on the configuration of the system.

Similar to the embodiments discussed above, landing page module 504 can transmit requests to first and second content provider 508, 510 for new content. If new content is available, landing page module 504 replaces the old content displayed on the landing page with the new content. It should be appreciated that, when the landing page is updated, server 502 may receive update messages from first content provider 508 and/or second content provider 510, or may request first content provider 508 and/or second content provider 510 for any updates to the landing page. As discussed above, when server 502 receives update messages, server 502 may directly or indirectly transmit the updated content to landing page module 504.

Because content has changed on the landing page, the webpage containing the links to the landing page has to be changed accordingly to correctly refer to the new content. Below is a description on how the links on the webpage that relate to the new content on the landing page may be efficiently updated.

In one embodiment, webpage module 506 periodically transmits a request message to, for example, first and/or second content provider 508, 510 for any updates on the landing page. If first and/or second content provider 508, 510 has replaced old content with new content on the landing page, first and/or second content provider 508, 510 transmits an update message informing webpage module 506 that new content has been added on the landing page. The message may also include a link to the new content, or a separate message can be sent containing the link. Webpage module 506 can then replace the old link with the new link on the webpage in order to accurately display the new link for the new content.

In another embodiment, when first and/or second content provider 508, 510 has replaced old content with new content on the landing page, first and/or second content provider 508, 510 can automatically transmit an update message to webpage module 506 that landing page has been updated with new content. The message may also include a link to the new content. This can allow webpage module 506 to automatically replace the old link with the new link on the webpage.

In yet another embodiment, webpage module 506 periodically transmits an update request to, for example, landing page module 504 for new content. If landing page module 504 has replaced old content with new content on the landing page, landing page module 504 transmits an update message informing webpage module 506 that the landing page has been updated with new content. The message may also include a link to the new content. Webpage module 506 can then replace the old link with the new link on the webpage in order to accurately display the new link for the new content.

In yet a further embodiment, when landing page module 504 has replaced old content on the landing page with new content on the landing page, landing page module 504 can automatically transmit an update message to webpage module 506 that the landing page has been updated with new content. The message may also include a link to the new content. This allows webpage module 506 to automatically replace the old link with the new link on the webpage.

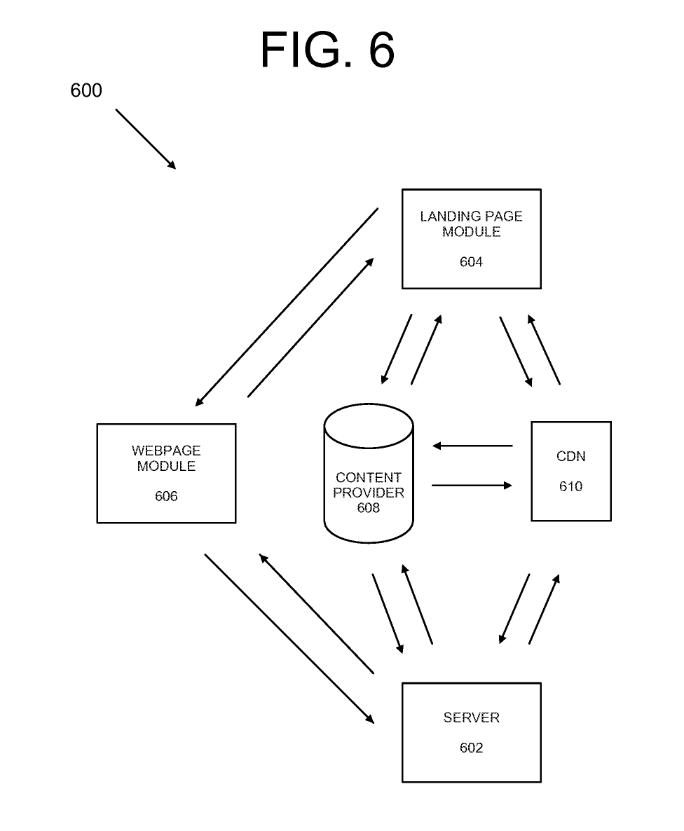

FIG. 6 illustrates a system 600 for automatically updating links on a webpage, in accordance with an embodiment of the present invention. System 600 includes a server 602, a landing page module 604, a webpage module 606, at least one content provider 608, and a content delivery network (CDN) 610. It should be appreciated that system 600 may include a plurality of landing page modules and webpage modules, depending on the configuration of the system.

In this embodiment, when content provider 608 has new content to be displayed on the landing page, content provider 608 transmits new content to landing page module 604 and/or CDN 610, and also transmits a link to the new content to server 602. If CDN 610 receives the new content, then CDN 610 may automatically push the new content to landing page module 604, so landing page module 604 can replace the old content with the new content on the landing page. It should also be appreciated that CDN 610 may also receive a link to the new content. Landing page module 604 may then cause webpage module 606 to display the new link.

In an alternative embodiment, landing page module 604 can transmit a request message to content provider 608 and/or CDN 610 for new content to be added on the landing page. If content provider 608 has new content, content provider 608 transmits the new content to landing page module 604 so landing page module 604 can replace the old content with the new content on the landing page. Similarly, if CDN 610 has new content that was received from content provider 608, CDN 610 transmits the new content to landing page module 604 so landing page module 604 can replace the old content with the new content on the landing page. CDN 610 may also transmit a link to the new content to server 602. Server 602 may then cause webpage module 606 to display the new link.

Because content has changed on the landing page, the webpage containing the links to the landing page also has to be changed to correctly refer to the new content. Below is a description of how the links on the webpage that relate to the new content on the landing page may be efficiently updated.

In this embodiment, webpage module 606 can transmit a request message to server 602 and/or landing page module 604 for updates to the landing page. If the landing page has been updated with new content, server 602 and/or landing page module 604 can transmit an update message to webpage module 606 to indicate that the landing page has new content that is being displayed. The update message may also include a link so webpage module 606 can update or replace the old links with the new links to accurately describe the new content that is being displayed on the landing page.

Although not illustrated in FIG. 6, webpage module 606 can request CDN 610 and/or content provider 608 for updates to the landing page. Based on the reply, webpage module 606 can update or replace the old links with the new links on the webpage to accurately describe the new content that is being displayed on the landing page.

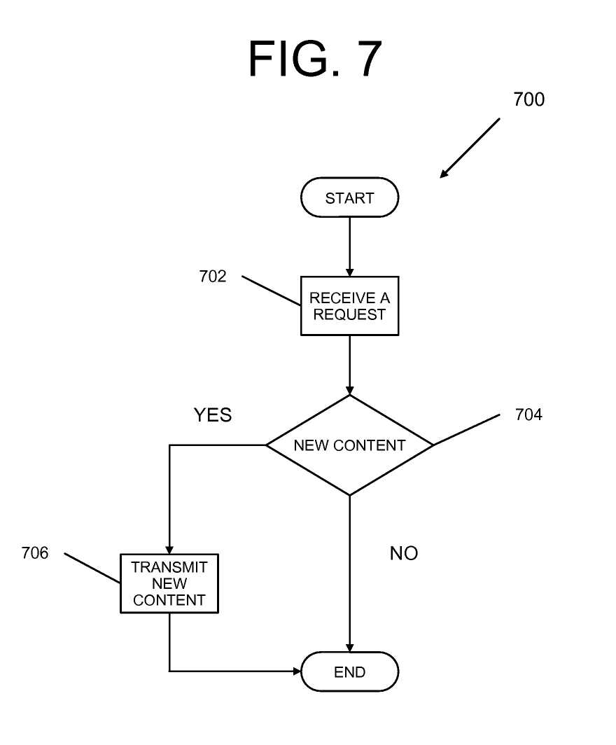

FIG. 7 illustrates a method 700 for transmitting new content, in accordance with an embodiment of the present invention. At 702, a content provider receives a request from another entity. The entity can be a landing page module, a CDN, and/or a server. The request can be for new content to be added on the landing page. At 704, the content provider determines whether it has new content that is to be displayed on the landing page. If the content provider does not have new content, then the content provider does not respond or, in the alternative, may respond with a message informing that there is no new content at this time. If the content provider determines that there is new content, then at 706 the content provider transmits an update message containing the new content to the other entity.

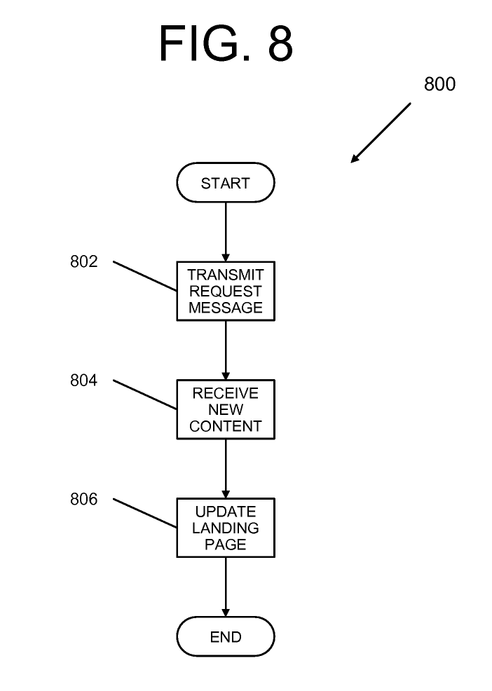

FIG. 8 illustrates a method 800 for automatically updating a landing page with new content, in accordance with an embodiment of the present invention. At 802, a landing page module transmits a request message to another entity for new content that is to be displayed on the landing page. The other entity can be a content provider, a CDN, and/or a server. At 804, the landing page module receives an update message from the other entity. The update message can include the new content that is to be displayed on the landing page. At 806, the landing page module automatically updates the landing page. For example, the landing page module replaces the old content with the new content on the landing page.

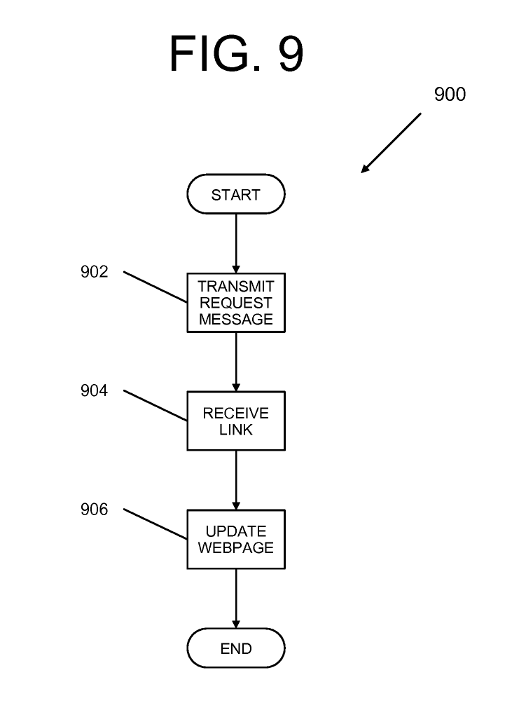

FIG. 9 illustrates a method 900 to automatically update links on a webpage, in accordance with an embodiment of the present invention. At 902, webpage module transmits a request message to another entity for updates to the landing page. The other entity can be a content provider, a landing page module, a CDN, or a central (or state) server. At 904, the webpage module receives an update message from the other entity that the landing page has been updated. The update message can include a link to the new content on the landing page. At 906, a webpage module replaces the old link with the new link on the webpage, such that the webpage will display the new link instead of the old link.

The method steps shown in FIGS. 7-9 may be performed, in part, by a computer program, encoding instructions for a nonlinear adaptive processor to cause at least the methods described in FIGS. 7-9 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data. The computer program may include encoded instructions for controlling the nonlinear adaptive processor to implement the method described in FIGS. 7-9, which may also be stored on the computer readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

One or more embodiments described herein pertain to automatically updating links on a webpage when the content on a landing page has changed. For example, when old content has been replaced by new content on the landing page, the links associated with the new content are automatically updated. It should be appreciated that the links can be updated using a meta tag or a Java Script that is embedded within the webpage.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
a processor; and
memory comprising instructions, wherein
the instructions, when executed by the processor, are configured to cause the apparatus to:
receive a content update message when content on a landing page is updated, and
transmit an update message to a server of a webpage to automatically update a link on the webpage to reflect the updated content on the landing page.

2. The apparatus of claim 1, wherein the update message comprises an updated link identifying the updated content on the landing page.

3. The apparatus of claim 1, wherein the content update message is received from a content provider.

4. The apparatus of claim 1, wherein the content update message is received from a server of the landing page.

5. The apparatus of claim 1, wherein the instructions, when executed by the processor, are further configured to cause the apparatus to:
receive an update request message from the server of the webpage requesting for an updated link for the updated content in the landing page,
determine if the content on the landing page is updated, and
transmit the updated link to the server of the webpage when the content on the landing page is updated.

6. The apparatus of claim 5, wherein the determine if the content on the landing page is updated comprises:
transmit a request message for an updated link to the server of the landing page, and
receive a response message identify whether content is updated on the landing page, the response message comprising an updated link when the content on the landing page is updated.

7. A computer-implemented method, comprising:
receiving, by a computing system, a content update message when content on a landing page is updated, and
transmitting, by the computing system, an update message to a server of a webpage to automatically update a link on the webpage to reflect the updated content on the landing page.

8. The computer-implemented method of claim 7, wherein the update message comprises an updated link identifying the updated content on the landing page.

9. The computer-implemented method of claim 7, wherein the content update message is received from a content provider.

10. The computer-implemented method of claim 7, wherein the content update message is received from a server of the landing page.

11. The computer-implemented method of claim 7, wherein the instructions, when executed by the processor, are further configured to cause the apparatus to:
receiving, by the computing system, an update request message from the server of the webpage requesting for an updated link for the updated content in the landing page,
determining, by the computing system, if the content on the landing page is updated, and
transmitting, by the computing system, the updated link to the server of the webpage when the content on the landing page is updated.

12. The computer-implemented method of claim 11, wherein the determining if the content on the landing page is updated further comprises:
transmitting, by the computing system, a request message for an updated link to the server of the landing page, and
receiving, by the computing system, a response message identifying whether content is updated on the landing page, the response message comprising an updated link when the content on the landing page is updated.

13. An apparatus, comprising:
a processor; and
memory comprising instructions, wherein the instructions, when executed by the processor, are configured to cause the apparatus to:
transmit a request message to a server of a landing page for updates to content of the landing page,
receive a response message from the server of the landing page when the content of the landing page is updated, and
transmit an update message to a server of a webpage to automatically update a link on the webpage.

14. The apparatus of claim 13, wherein the response message comprises an updated link for the updated content on the landing page.

15. The apparatus of claim 13, wherein the update message comprises an updated link for the update content on the landing page.

16. The apparatus of claim 13, wherein the instructions, when executed by the processor, are further configured to cause the apparatus to transmit a request message to at least one content provider for updates to the content of the landing page.

17. The apparatus of claim 16, wherein the instructions, when executed by the processor, are further configured to cause the apparatus to receive a response message comprising an updated link from the at least one content provider when the content of the landing page is updated.

18. The apparatus of claim 13, wherein the instructions, when executed by the processor, are further configured to cause the apparatus to:
receive an update request message from the server of the webpage requesting for an updated link for updated content in the landing page,
determine if the landing page has been updated content, and
transmit the updated link to the server of the webpage when the content of the landing page is updated.

19. An apparatus, comprising:
at least one processor; and
memory comprising a computer program, wherein
the computer program, when executed by the at least one processor, is configured to cause the apparatus to:
receive a content update message comprising at least one updated link identifying updated content on a landing page; and
automatically update at least one link on a webpage with the at least one updated link.

20. The apparatus of claim 19, wherein the content update message is received from a central server, a server of a landing page, or at least one content provider.

21. The apparatus of claim 19, wherein the computer program, when executed by the at least one processor, is further configured to cause the apparatus to transmit a request message to a central server, a server of the landing page, or at least one content provider for updates to content on the landing page.
